(19) United States
(12) Patent Application Publication
(10) Pub. No.: US 2016/0312518 A1
(43) Pub. Date: Oct. 27, 2016

(54) DEVICE FOR CLOSING AN OPENING IN A BUILDING

(71) Applicant: Walter DEGELSEGGER, Desselbrunn (AT)

(72) Inventor: Walter DEGELSEGGER, Desselbrunn (AT)

(21) Appl. No.: 15/102,819

(22) PCT Filed: Dec. 13, 2014
(86) PCT No.: PCT/AT2014/000221

§ 371 Date: Jun. 8, 2016

(30) Foreign Application Priority Data
Dec. 13, 2013 (AT) A957/2013

(51) Int. Cl. E06B 1/16

(52) U.S. Cl. CPC E06B 1/16

(57) ABSTRACT

A device for closing a building opening, wherein a planar closure element and/or a frame rigidly attached to the edge of the building opening has a frame profile, which by way of two lateral surfaces delimits a profile cavity that is open toward the rebate face, wherein from each of the two lateral surfaces, a profile wall projects toward the direction of the respective other lateral surface. On the projecting profile walls, a metal cover plate and a clamping part are attached such that they are pulled together by screws, with the interposition of the profile walls. On the two projecting profile walls, a clamping part abuts, in each case, both flanks of a groove, the opening surface of which is parallel to the connecting surface between the two projecting profile walls.

The invention relates to a device which comprises a casing and an areal closure element and which serves for closing a building opening, wherein the areal closure element and/or the casing which is fastened rigidly to the edge of the building opening has a frame profile which comprises a cavity, which is open toward the rebate surface, on three sides.

In this document, the expression “rebate surface” refers to the surfaces oriented at least approximately normal to the plane of the areal closure element, at which surfaces, when the wall opening is closed, areal closure elements lie so as to face toward one another or areal closure element and casing lie so as to face toward one another.

In the context of this document, an “areal closure element” is typically a window leaf or a door leaf, regardless of the manner in which the mobility thereof is guided, that is to say for example regardless of whether, in the case of a door, it is a pivoting door, folding door, sliding door, sectional door, sliding and folding door, etc.

Documents DE19509206 A1, DE19931171 A1, DE29812574 U1, EP1020605 A2 and DE19733415 B4 present leaves, in the form of so-called “all-glass leaves”, of pivoting doors or windows. Here, two glass panes which are arranged parallel to one another and with a spacing to one another are adhesively bonded to one another with the interposition of a spacer profile which runs along the edge of both panes. Furthermore, here, that side of the spacer profile which remains free is equipped with a so-called fitting groove. A so-called “fitting groove” (a standardized design thereof is, in technical circles, also sometimes referred to as “Eurogroove”) is known in particular in the case of window frame profiles. It is a shallow groove which may have an opening area which is constricted by projections from the groove flanks. The fitting groove serves for slidingly guiding push rods in the case of turn/tilt-and-turn type windows and for facilitating the positioning of fittings, or of bores and milled-out portions for these, in the directions normal to the window plane. It generally does not serve to eliminate the need for drilling and milling work.

DE 198 60 217 A1 presents a pivoting door, which is intended for use as a household door, in the case of which the door leaf is composed of a rectangular panel-like core composed of an insulating material, a for example metallic profile frame, and two outer layers, wherein the profiles of the profile frame have a groove which is open toward the rebate surface. The profile frame runs around the core on the end surfaces thereof. The outer surfaces run on both sides of the core and profile frame, in parallel to the common plane thereof, and are adhesively bonded both to the core and to the profile frame, such that a stable sandwich is formed. At the opening area of the groove, which is open toward the rebate surface, of the profile frame, there projects from each of the two groove flanks in each case one short profile wall oriented normal to the groove flanks. In intended use, hinge fitting parts or a lock can be fastened in said groove. The profile walls which project from the groove flanks presumably serve as a fastening aid. On the underside of the door leaf, the groove is closed off by way of a cladding strip to prevent the ingress of dirt. To realize high stability of the pivoting door which is proposed as a household door, the profiles of the profile frame are of very large dimensions and are covered by the outer layers of the door leaf and thus adhesively bonded. For use as automatically closing and opening fire protection doors, the construction is nevertheless not stable enough.

High mechanical loads on a pivoting door arise not only owing to the weight thereof or if it has to withstand a brake-in. An extreme usage situation with regard to the frequency of occurrence and severity of the mechanical loads is that of pivoting doors which, owing to safety requirements, must have an automatic closing and opening mechanism, such as is typically the case with fire protection doors, in particular in the case of two-leaf fire protection doors. In the case of such doors, the most intense mechanical load consists in that, under standardized tests, they must perform five hundred thousand to one million automatically triggered opening and closing cycles without interruption, without even a single part or a single connection failing to such an extent that the function is no longer reliably performed. (The stated number of test cycles is dependent on country-specific standards.) Two-leaf pivoting doors as fire protection doors have not only closing sequence regulation, which must have the effect that the overlying leaf (active leaf) is always reliably closed after the underlying leaf (inactive leaf), but also opening sequence regulation, which must have the effect that, when the inactive leaf is opened, the active leaf is imperatively also opened at least to the minimum opening angle beyond which it is ensured that the closing sequence regulation functions reliably. In particular, during the test of the opening sequence regulation, in the case of which the inactive leaf is opened by an external actuating device and, accordingly, by way of a transmission mechanism installed in the door, the active leaf is automatically jointly opened at least as far as said minimum opening angle, extremely high forces briefly also act in individual fitting parts owing to lever ratios which are unfavorable (close to a dead center) in some opening angle ranges.

Specifically in the case of such doors, numerous fitting parts have to be attached into and onto the casing and onto the leaves, such that the possibility of fast, easy and flexibly adjustable installation of fitting parts in profile grooves without the need for separate bores or milled-out portions would be economically highly desirable. Owing to the difficulties that arise from the described mechanical requirements, this has however hitherto not been possible in a satisfactory manner.

The main problem on which the invention is based consists in proposing a design for a closable building opening in the form of a window, door or gateway, wherein the movable closure element(s) and/or the casing rigidly fastened to the edge of the building opening have a frame profile, the cross-sectional area of which comprises a cavity, which is open toward the rebate surface, on three sides. In relation to known designs in which such a cavity is provided, the design to be realized is intended to permit the following combination of improvements, with good economic efficiency and without the need to accept aesthetic disadvantages:
the cavity which is open toward the rebate surface should be able to have such a large cross-sectional area that all required fittings can be positioned therein without the need for the frame profile to be drilled or milled.
The design should make it possible to realize such high mechanical strength that, accordingly, it is also possible to construct pivoting doors with high mechanical load such as in particular fire protection doors with automatic opening and closing sequence regulation, specifically without it being necessary to form a sandwich from frame profiles and outer surfaces of a door leaf.

An important secondary problem is that of achieving that the work outlay for the production of the movable closure elements and of the casings is low.

To solve the problems, a design is taken as a starting point in which a frame profile delimits a cavity, which is open toward the rebate surface, by way of three delimiting surfaces which are arranged in approximately U-shaped fashion with respect to one another in cross section, wherein, from the two side delimiting surfaces, there projects in each case profile wall which locally narrows the width of the cavity in the cross-sectional view, wherein fitting parts can be fastened to the projecting profile walls with the aid of a clamping part, by virtue of the projecting profile walls being clamped in between and by virtue of the clamping part and fitting part bridging the cavity between the two projecting profile walls.

As an improvement according to the invention, it is proposed that the connection between clamping part and projecting profile walls, and/or the connection between fitting part and projecting profile walls, be designed such that it blocks, in form-fitting fashion, relative movement between the projecting profile walls away from one another and toward one another. To realize said form-fitting blocking action, the contact geometry between projecting profile walls and clamping part and/or fitting part is designed such that, on the two projecting profile walls, the clamping part and/or the fitting part bears in each case against both flanks of a groove which is formed on each of the projecting profile walls and the opening area of which lies parallel to the connecting surface between the two projecting profile walls.

In a particularly preferred embodiment, said groove on the projecting profile walls is designed such that the spacing between the flanks of said groove at the region against which the clamping part and the fitting part bear narrows with increasing groove depth. Thus, a play-free form fit between the frame profile and the clamping part and/or fitting part can be achieved in a particularly straightforward and reliable manner.

In a further particularly preferred embodiment, the cross-sectional area of the frame profile has no closed hollow chambers. Advantages that can be achieved by this relate to producibility, fire protection and connectability to parts which are arranged on that side of the frame profile which is averted from the opening side of the cavity.

The significance of the invention is clear in particular from the numerous applications in which the design according to the invention yields considerable advantages or which are actually made possible in the first place by way of the design according to the invention. Aside from the basic principle of the invention, a number of such exemplary applications will therefore be depicted and described below.

The invention, including advantageous further developments thereof, will be discussed in more detail on the basis of somewhat stylized drawings of advantageous exemplary embodiments, and new applications made possible by these will be discussed in more detail:

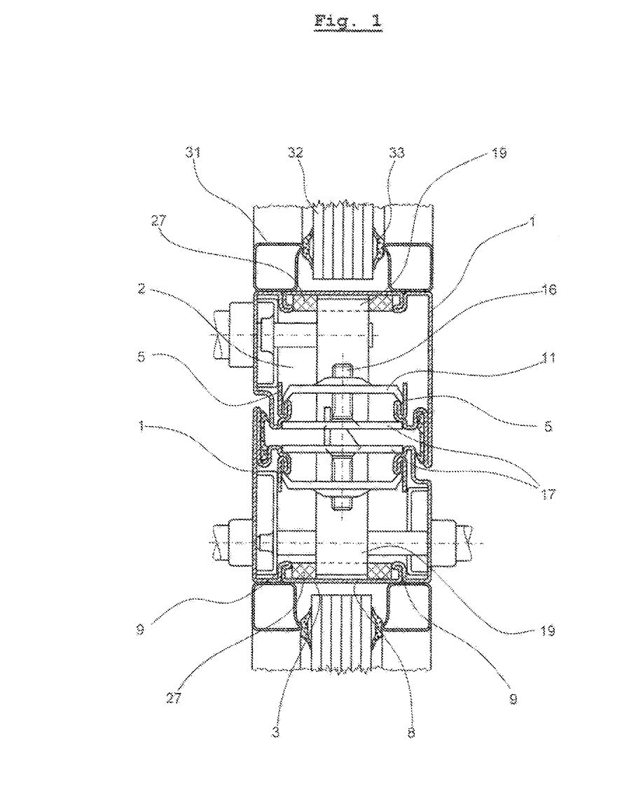

FIG. 1 shows, in a horizontal sectional view, two edge regions, facing toward one another, of exemplary leaves, designed according to the invention, of a two-leaf pivoting door.

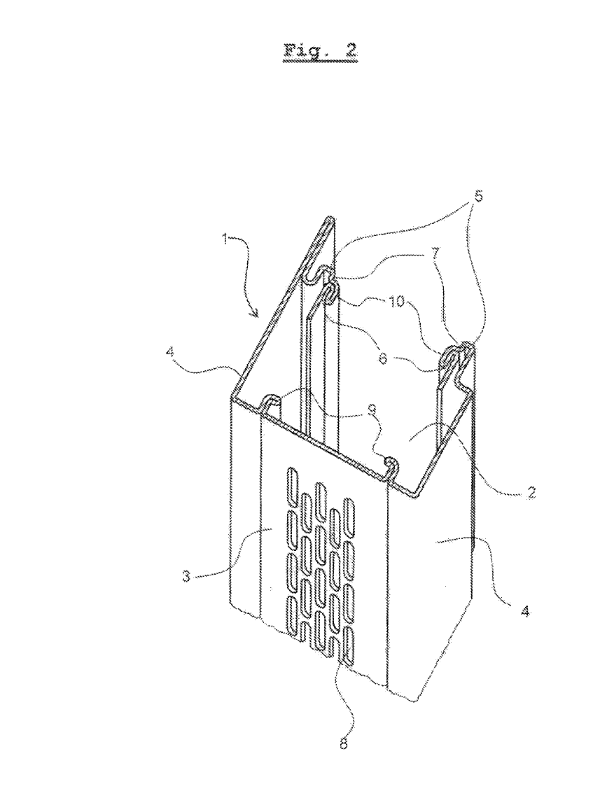

FIG. 2 shows, in an oblique view, the frame profile according to the invention used in the leaves of FIG. 1.

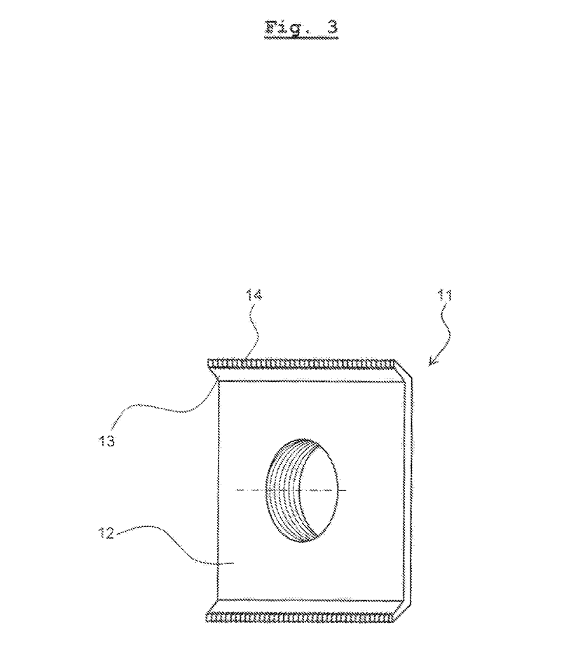

FIG. 3 shows, in an oblique view, an exemplary clamping part according to the invention as used in the example as per FIG. 1.

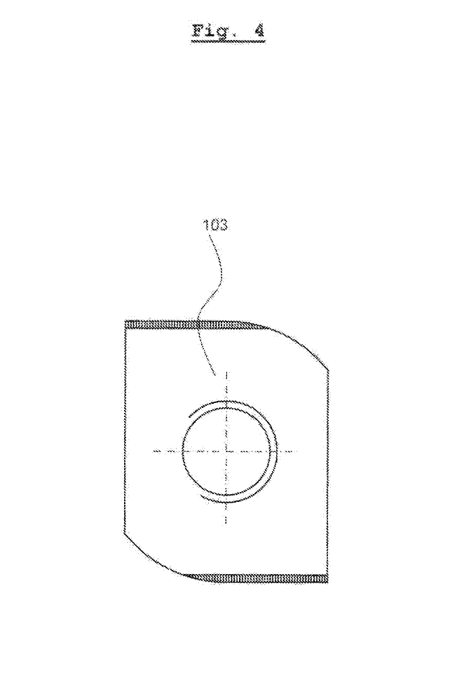

FIG. 4 shows, in a front view, a further clamping part according to the invention.

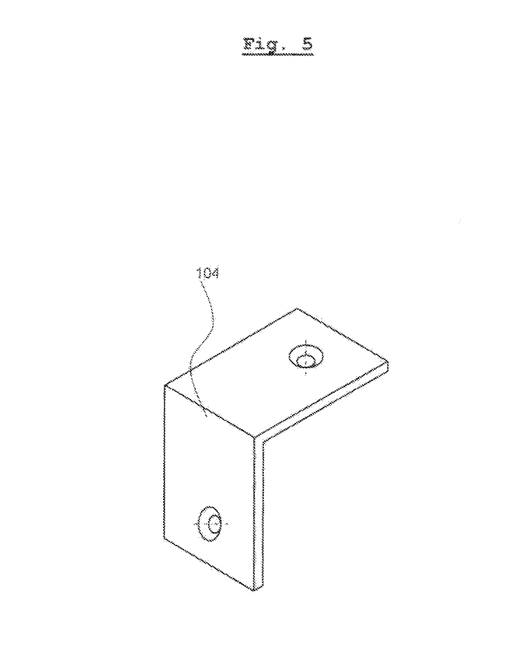

FIG. 5 shows, in an oblique view, an exemplary corner angle piece for the connection of two frame profiles according to the invention across a miter surface, wherein the two limbs of the corner angle piece each constitute a cover plate.

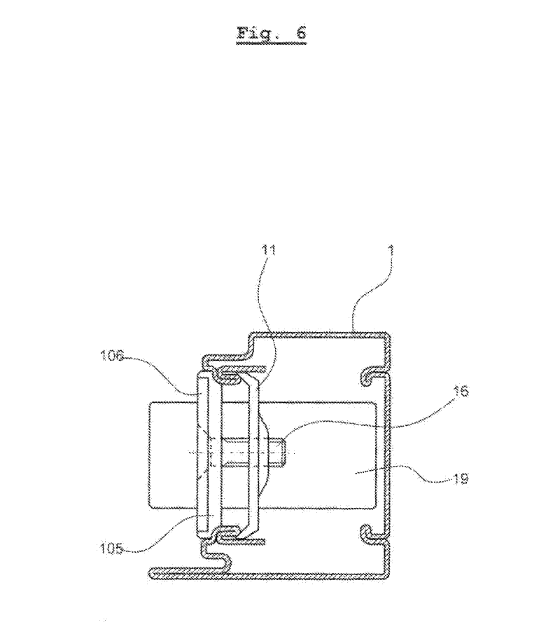

FIG. 6 shows, in a sectional view, the installation, according to the invention, of a fitting into a frame profile using a heat insulator on the cover plate.

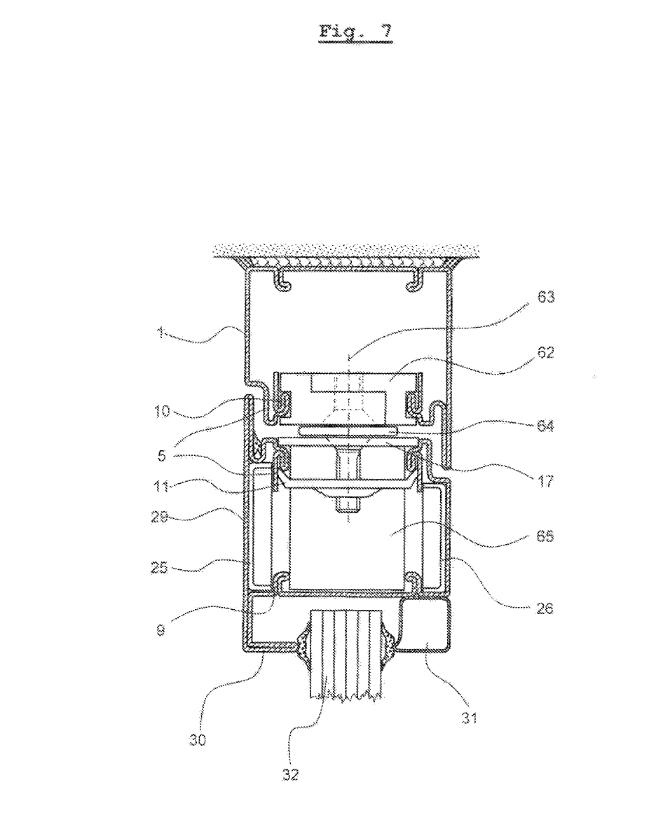

FIG. 7 shows, in a vertical sectional view, an exemplary design according to the invention in the application with a slide-rail-type door closer.

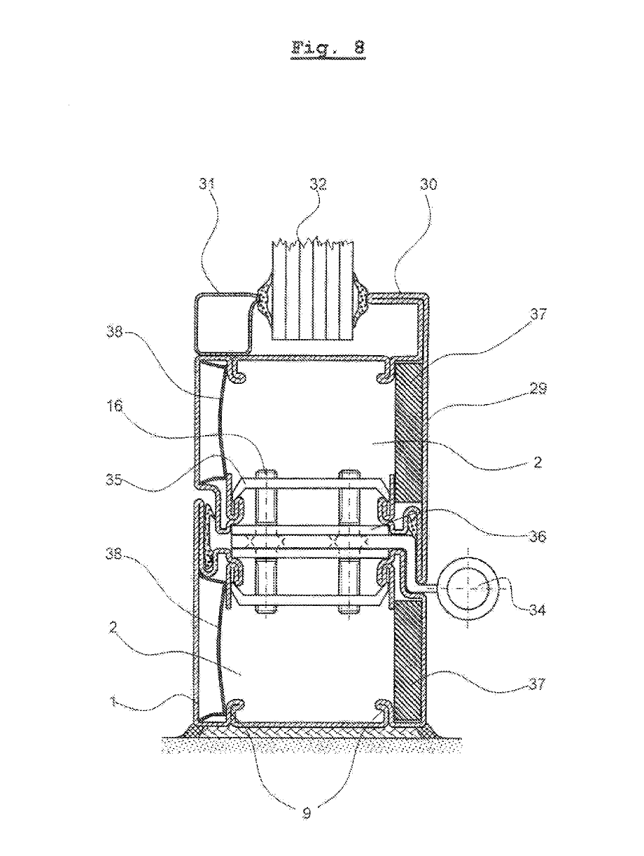

FIG. 8 shows, in a horizontal sectional view, the hinge region of an exemplary pivoting door designed according to the invention, which is additionally equipped with heat shields and fire protection bodies.

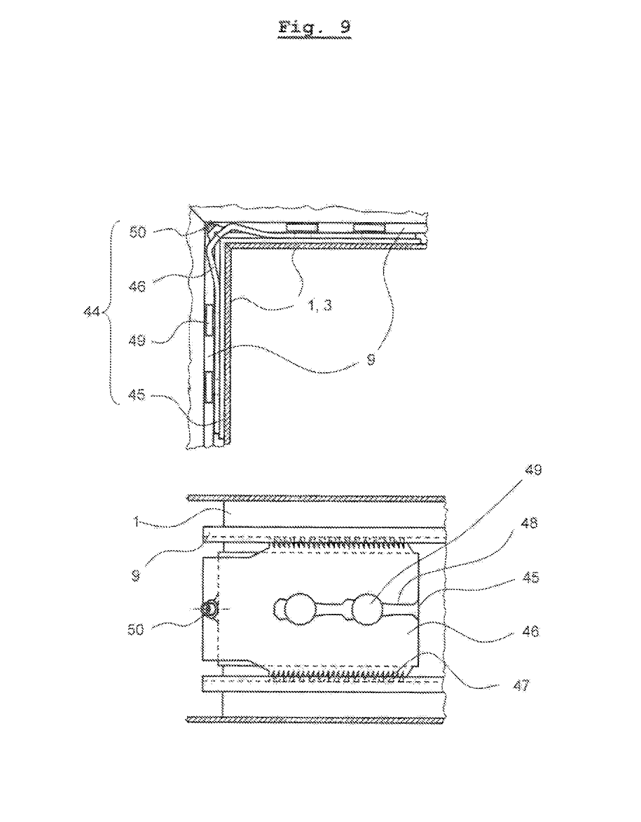

FIG. 9 shows, in a horizontal and in a vertical partially sectional view, an advantageous form of the corner connection between two frame profiles used in accordance with the invention.

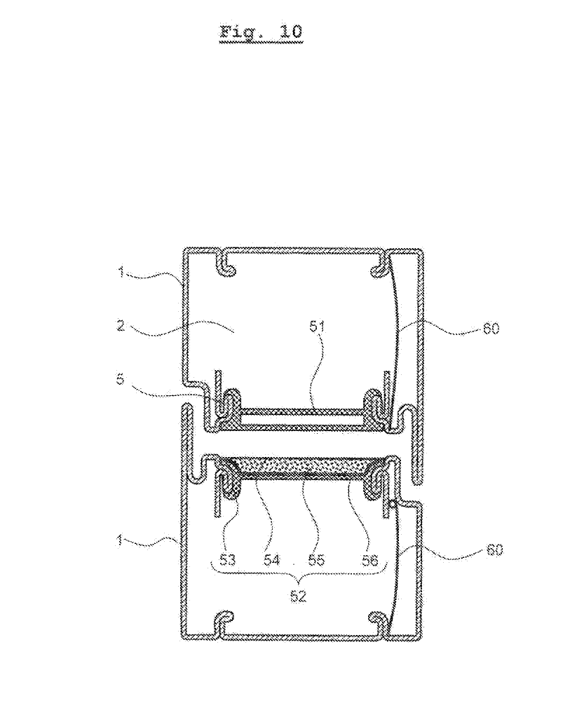

FIG. 10 shows, in a sectional view, the arrangement of heat guard components and concealment profiles in frame profiles used in accordance with the invention.

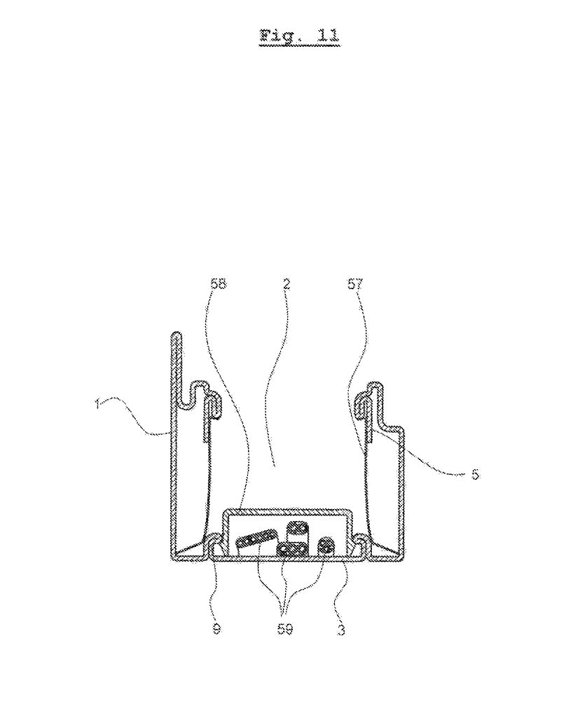

FIG. 11 shows, in a sectional view, the arrangement of heat guard components, cables and a cable channel in a frame profile used in accordance with the invention.

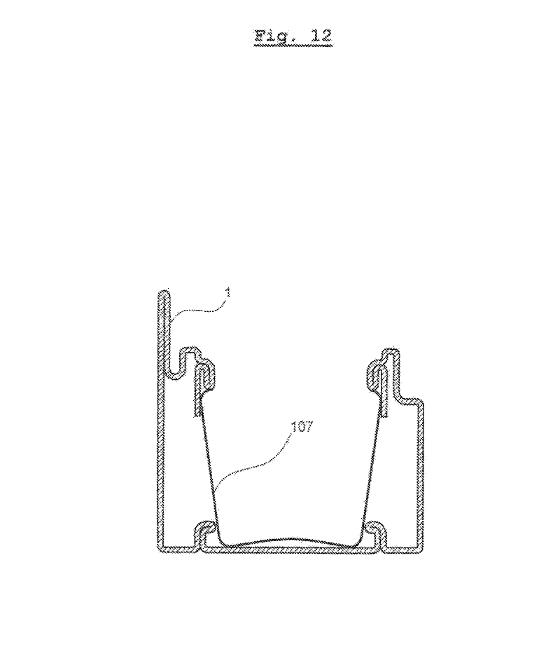

FIG. 12 shows, in a sectional view, a further heat shield in a frame profile according to the invention.

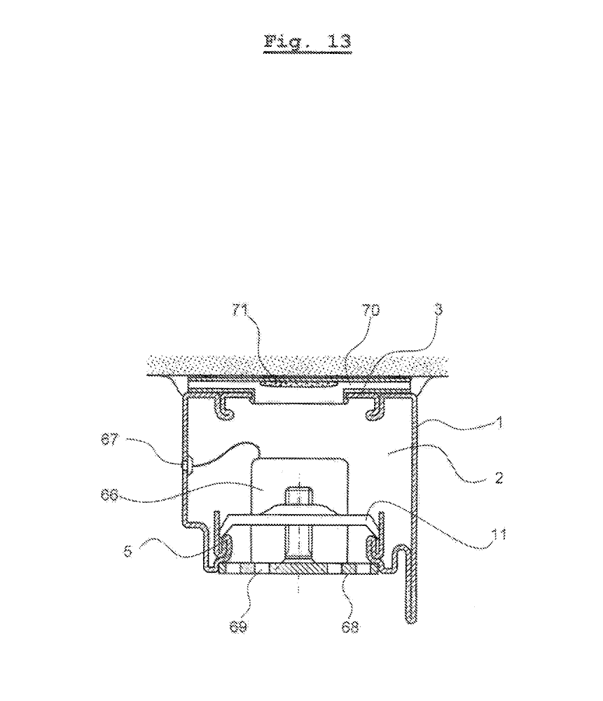

FIG. 13 shows, in a sectional view, the arrangement of a smoke detector in a frame profile used in accordance with the invention.

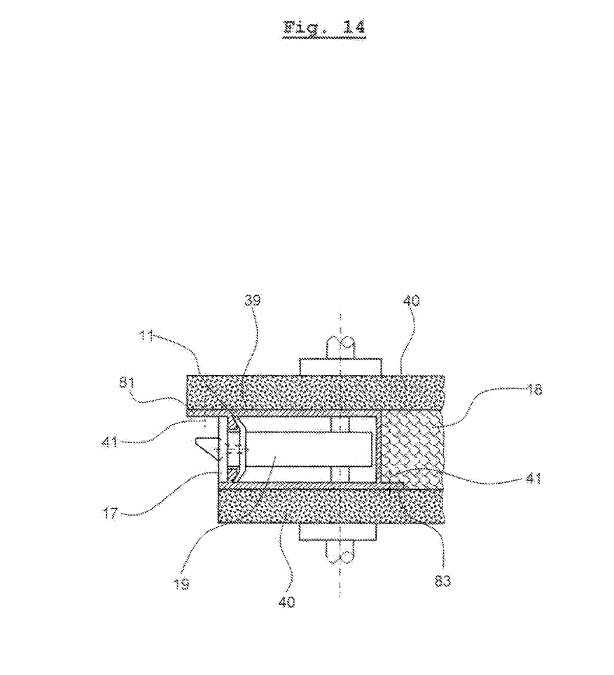

FIG. 14 shows, in a sectional view, a design according to the invention on a door leaf composed of wood.

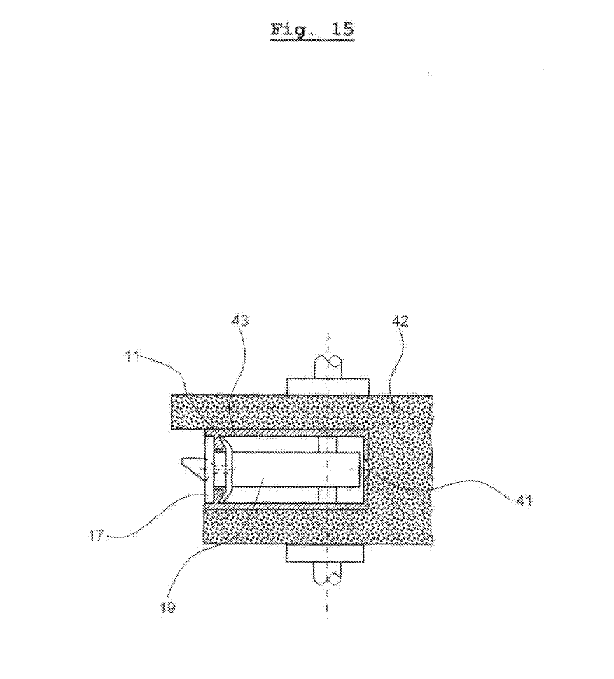

FIG. 15 shows, in a sectional view, a design according to the invention on a further door leaf composed of wood.

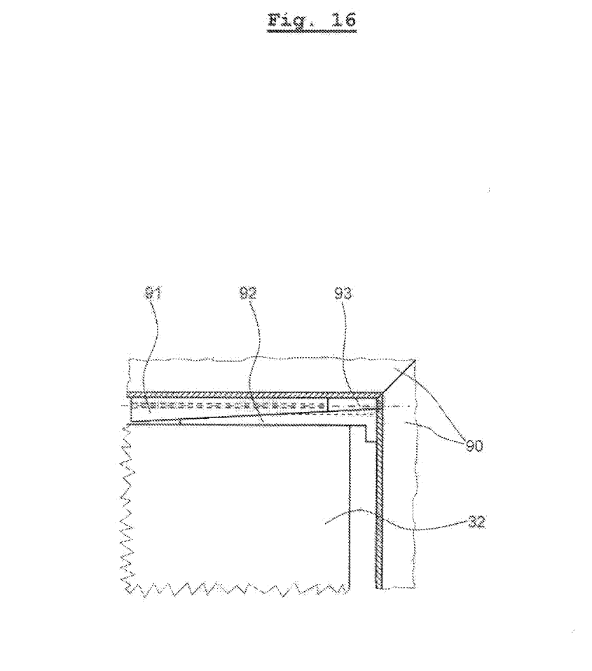

FIG. 16 shows, in a partially sectional view, with a section plane parallel to the door leaf plane, an advantageous arrangement of a block arrangement on a door leaf designed according to the invention.

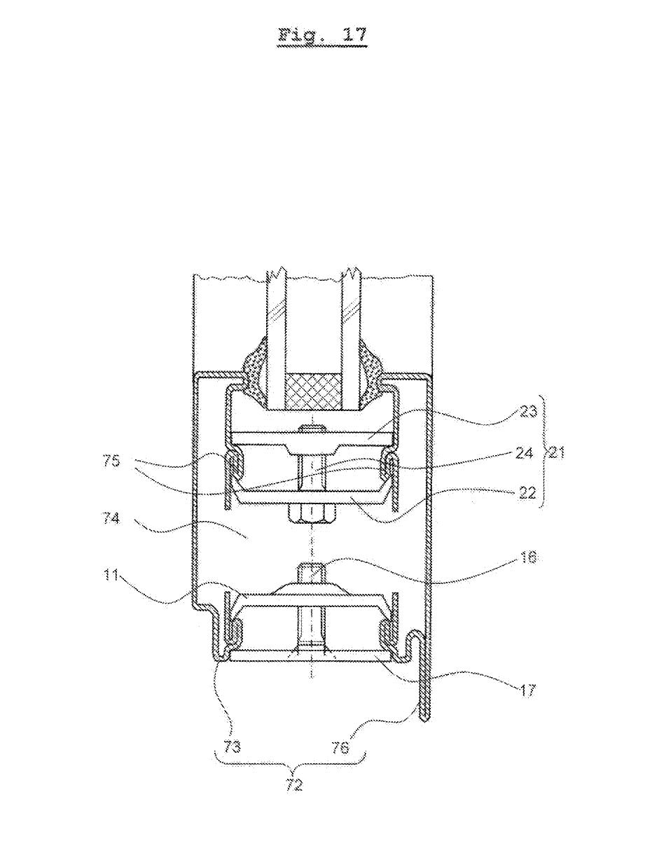

FIG. 17 shows, in a sectional view, and on a door leaf, the use of a frame profile used in accordance with the invention, said frame profile being formed from two separate profile parts.

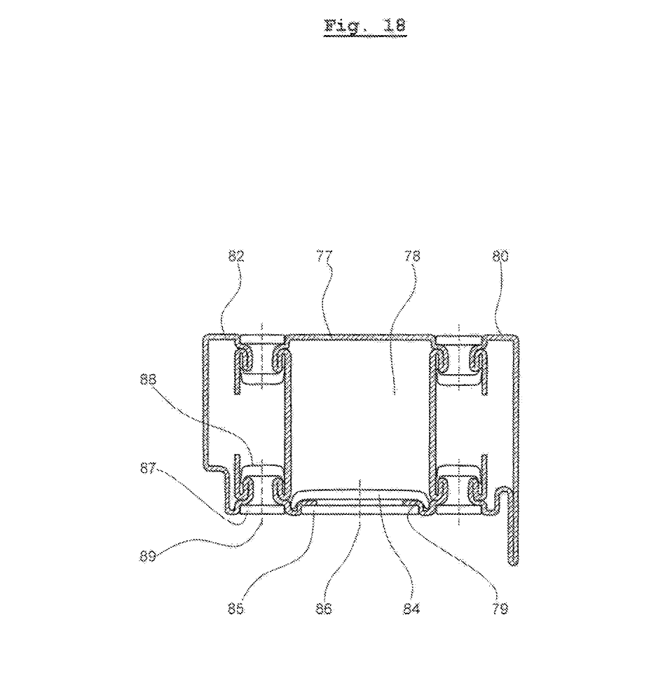

FIG. 18 shows, in a sectional view, a frame profile which can be used in accordance with the invention and which has laterally doubled-up additional profiles.

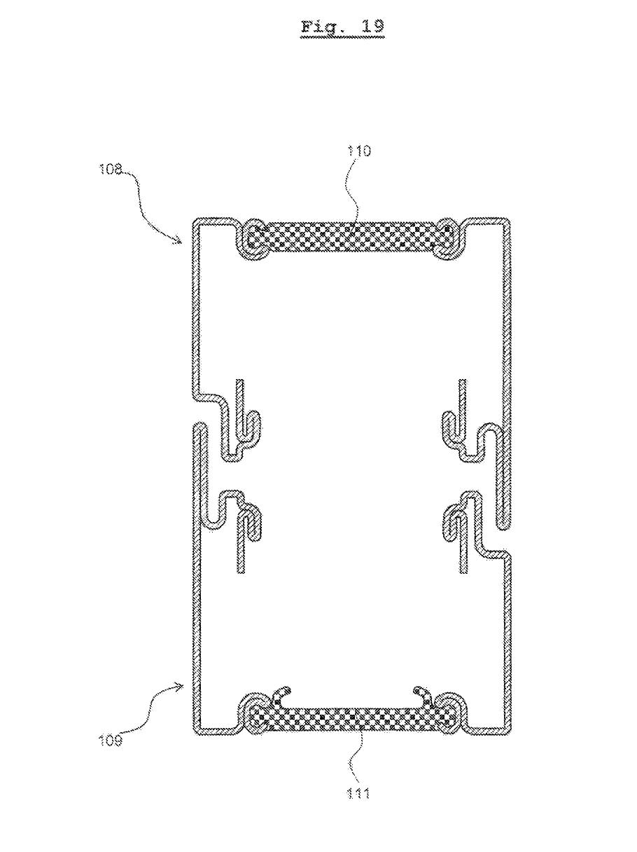

FIG. 19 shows, in a sectional view, two frame profiles which can be used in accordance with the invention and which are each formed from a composite profile composed of three sub-profiles, wherein the respective central profile is formed from a thermally insulating material.

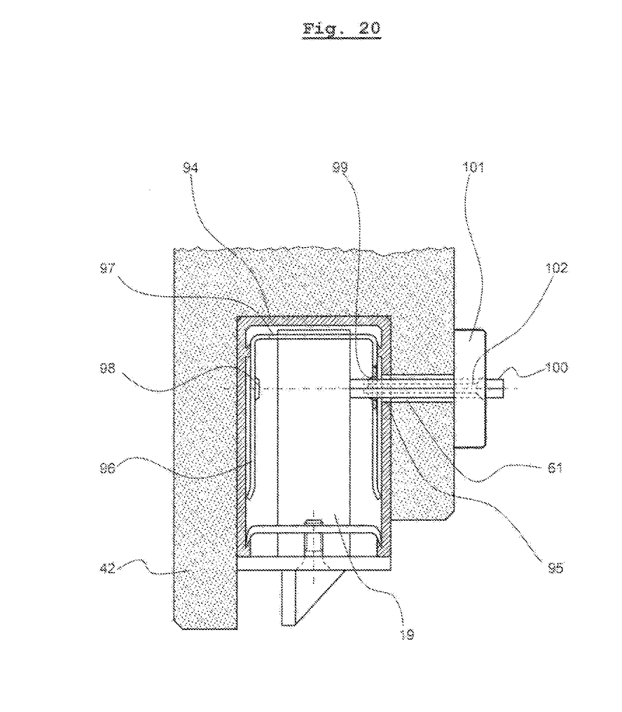

FIG. 20 shows, in a profile view, an advantageous installation configuration for handle and lock casing in a frame profile used in accordance with the invention.

FIG. 1 shows the mutually facing region of two pivoting door leaves which, aside from the fittings, are formed from a glass pane 32 and from a frame which surrounds said glass pane and which is formed from frame profiles 1 and glass strips 31.

The frame profile 1 is typically formed from sheet steel by roll forming. Details of the frame profile 1 can, in part, be seen more clearly in FIG. 2 than in FIG. 1. Said frame profile has substantially a U-shaped cross-sectional shape, and, as such, surrounds the profile cavity 2 on three sides in a cross-sectional view, wherein the open side of the profile cavity is oriented in each case toward the rebate surface, that is to say toward the respective other frame profile 1 in the case of FIG. 1.

In the example illustrated in FIG. 1, the glass pane 32 of each pivoting door leaf is held on the frame profiles 1 by being clamped along its edges in each case between two glass strips 31, with the interposition of an elastic sealing profile 33. The glass strips 31 are also profiles which are typically formed by roll forming and seam welding of a sheet-steel strip. The glass strips 31 bear in each case against the outer side of the base surface 3 (FIG. 2) of a frame profile 1 and are connected to the frame profile 1.

Typically, the connection between a glass strip 31 and a frame profile 1 is formed by virtue of screws extending from the cavity 2 of the frame profile 1 through the base surface 3 of said frame profile, and through the abutting wall of the glass strip 31, into the profile cavity of the glass strip 31. In this way, a secure and detachable connection is formed without fastening elements being visible from the outside. For space reasons, and for ease of handling, it has proven to be advantageous here for the frame profile 1 to not be a hollow profile.

Close to the opening area of the cavity 2, at the same height above the base surface 3 of the frame profile 1, a profile wall 5 projects from each of the two lateral surfaces 4 (FIG. 2) of the frame profile 1 toward the cavity 2, such that the width of the cavity 2 is, in the height region of the two profile walls 5, narrowed in relation to the width in adjacent height regions.

FIG. 1 furthermore shows the installation, according to the invention, of a fitting 19 in a frame profile 1, wherein, in this example, the fitting 19 is a lock casing. The fitting 19 is arranged substantially in the cavity 2. Said fitting is rigidly connected to a cover plate 17 which, on that side of the profile walls 5 which is averted from the base surface 3 of the frame profile 1, bears against said profile walls and thus covers the cavity 2.

At that side of the profile walls 5 which faces toward the base surface 3 of the frame profile 1, a clamping part 11 bears against the profile walls 5. A screw 16 bears by way of its head against the outer side of the cover plate 17. The threaded bolt of the screw 16 runs through a bore in the cover plate 17 and is in threaded engagement with a threaded bore in the central part 12 (FIG. 3) of the clamping part 11. By way of the tensile force exerted by the screw 16, the cover plate 17 and clamping part 11 are pushed together. The cover plate 17 and clamping part 11 are supported, so as to be prevented from moving toward one another, by the profile walls 5 against which they bear, such that the clamping part 11 and cover plate 17 exert, from opposite sides, a pressure force on in each case one projection 10 (FIG. 2) of the profile walls 5, said pressure force being equal in overall magnitude to the tensile force of the screw 3.

It is of major importance according to the invention that the contact surfaces between clamping part 11 and profile walls 5 of the frame profile 1 are not simply planar surfaces oriented normal to the screw 16, but rather that the clamping part 11, with its two edge regions 13 which project in relation to its central part 12 toward the profile walls 5, bears in each case against both flanks of in each case one groove 6 (FIG. 2), the groove base of which bears against a profile wall 5 and the opening area of which is oriented toward the base surface 3 of the frame profile 1 and the width of which at the contact region with the clamping part 11 increases continuously from the groove base toward the opening area.

By way of this design, it is achieved that the clamping part 11 realizes secure, play-free and form-fitting blockage of relative movements of the two side surfaces 4 of the frame profile 1 toward one another and away from one another. Said effect is also enhanced by the fact that the cover plate 17 is also held in form-fitting fashion, so as to be prevented from being displaced laterally relative to the frame profile 1, by virtue of in each case one wall region of a profile wall 5 bearing frontally against both lateral face walls of the cover plate 17, because the cover plate 17 bears against the profile walls 5 in each case in a corner region 7, at which a surface lying parallel to the base surface 3 of the frame profile 1 transitions into a surface averted therefrom and lying approximately normal thereto.

The frame profile 1 that is illustrated would, in itself, be capable of being relatively easily deformed such that its two side surfaces 4 are bent toward one another or away from one another. By way of the described arrangement of clamping parts 11, said softness is corrected, such that the frame profile 1, in those longitudinal regions on which clamping parts 11 are arranged, is of similar stiffness and strength to a closed hollow profile.

By way of the invention, it is thus possible, even for doors with extremely high mechanical demands, to provide lightweight and slim frame profiles 1 which have a cavity 2 which is open toward the rebate surface and in which fittings 19 can be conveniently accommodated, and which is moreover of single-walled form, that is to say without a hollow chamber, so as to be easy to produce and, if necessary, easy to machine. Clamping parts 11 have to be installed, as illustrated, only on those longitudinal regions of the frame profiles 1 at which high mechanical loads are to be expected. If necessary, as a complementary part to a clamping part 11, use may also be made of a cover plate 17 which is not connected to a fitting 19 but which is simply merely a plate which presses against the profile walls 5, from the side situated opposite the clamping part 11, owing to the force of screws 16.

In the advantageous embodiment illustrated in FIG. 1, the fitting 19 is, additionally to its retention on the cover plate 17, also held by a plate 27 so as to be prevented from moving normally to the plane of the frame formed from the frame profiles. For this purpose, the plate 27 is clamped between profile walls 9 which project into the profile cavity 2 from the base surface of the frame profile 1, and the fitting 19 is inserted into a milled-out portion in the plate 27.

As can be seen in FIG. 3, it is advantageous for the projecting edge regions 13 of the clamping part 11, by way of which said clamping part bears, during intended use, against grooves 6 of the frame profile 1, to be equipped with a toothing 14 such that, in the intended arrangement of the clamping part 11 on a frame profile 1 elevations and depressions alternate with one another, in the profile direction of the frame profile 1, on the contact surface of an edge region 13 with delimiting surfaces of the groove 6. Owing to the force with which the toothing 14 of the clamping part 11 is pressed into the groove 6, the tips of the toothing are pushed into the material of the frame profile 1, whereby the clamping part 11 is also held in form-fitting fashion in the frame profile 1 so as to be prevented from slipping in the profile direction.

FIG. 4 shows a design of a clamping part 103 whose edge regions, which are intended to be placed in engagement with a frame profile, are rounded at diagonally opposite end regions. The clamping part 103 is more convenient to install than the clamping part 11, because, for intended mounting in the profile cavity of the respective frame profile, it only needs to be pivoted about the axis of its threaded bore, and not about an axis normal thereto. This is important in particular if further objects are already arranged in the profile cavity, such that little space is available.

FIG. 5 shows, in an oblique view, an exemplary corner angle piece 104 for the connection of two frame profiles according to the invention across a miter surface. Here, as in the case of the cover plate 17 as per FIG. 1, the two limbs of the corner angle piece 104 are intended to bear against profile walls, which are to be clamped, of the frame profiles, and to be pressed by way of clamping part 11, 103 and screw 16 against the respective profile walls. By contrast to the cover plate 17 of FIG. 1, the limbs of the corner angle piece 104 bear only against those longitudinal regions of the respective profile walls which adjoin the miter surfaces. The corner connection is easy to realize in terms of installation and is highly stable.

In the case of the installation according to the invention, as depicted in FIG. 6, of a fitting 19 in a frame profile 1, the cover plate 106, which is connected to the fitting 19, bears against the frame profile 1 not directly but with the use of an intermediate insulation layer 105 composed of a thermally insulating, preferably also heat-resistant, material.

FIG. 7 depicts, by way of example, the way in which a frame profile 1 designed according to the invention can be used as a slide rail for a sliding block 62 of a slide-rail-type door closer.

In accordance with the functional principle, known per se, of slide-rail-type door closers, a sliding block 62 which is mounted so as to be linearly displaceable along the upper door casing part (formed by a frame profile 1) is connected via a pivotable arm 64 to a rotary drive 65 which is held on the upper edge of the pivoting door leaf so as to be positionally fixed relative thereto and which exerts, on the pivotable arm 64, a torque about an axis parallel to the pivot axis of the door leaf. (A reversed design is also possible, in which a sliding block which is mounted so as to be linearly displaceable along the upper edge of the door leaf is connected by way of a pivotable arm to a rotary drive which is arranged positionally fixedly on the upper door casing part.) By way of a design as depicted in FIG. 7, a frame profile 1 designed according to the invention can perform the function of the slide rail, which is otherwise in the form of a separate part. For this purpose, the sliding block 62 extends between the profile walls 5 which projects from the side surfaces 4 of the frame profile 1 (FIG. 2), and said sliding block is for this purpose provided, on each of its two side surfaces, with a groove into which in each case one projection 10 of a profile wall 5 projects, such that the grooves on the sliding block 62 act as sliding-guide grooves, with the projections 10 being parts complementary thereto.

With regard to installability, it is advantageous for the sliding block 62 to be formed, as depicted, from two parts which each extend only over approximately half of the width of the fitting groove and which are connected by way of screws 63 for the first time during the installation of the frame profile 1.

In a logical use of the present invention concept, it is also the case in FIG. 7 that the rotary drive 65 of the slide-rail-type door closer, on which the second end of the pivot arm 64 is held, is held in the cavity of a further frame profile 29 according to the invention. The fastening of the rotary drive 65 in the frame profile 29 is realized, in the same way as that of the fittings 19 of FIG. 1, by way of clamping parts 11, a cover plate 17 which is connected to the rotary drive 65, and screws which press the cover plate 17 and clamping parts 11 together, such that they clamp between them a part of the profile walls which project from the side walls of the frame profile 29. In the example of FIG. 7, the frame profile 29 forms the upper frame part of a pivoting door leaf. In this way, a visually extremely inconspicuous design of a slide-rail-type door closer is realized. The use of a separate slide rail is rendered unnecessary. Furthermore, highly simple installation is possible, with which, moreover, very good adjustability with regard to the position of the rotary drive 65 along the associated frame profile 29 is realized.

FIG. 7 also depicts a possible way in which adjacent frame profile 29 of a door leaf frame or of a casing can be connected to one another. For this purpose, two so-called corner clamping angle pieces 25, 26 are provided. Said corner clamping angle pieces 25, 26 are composed in each case of two identical profile limbs which are connected to one another at an angle of 90°. The cross-sectional areas of the profile limbs are dimensioned such that, on the frame profile 29, they can be inserted, with the formation of an interference fit, into in each case one undercut groove, such that they become stuck therein without play. In the advantageous embodiment illustrated in FIG. 7, the base surface of each undercut groove forms in each case the inner side of a side wall of the frame profile 29. The corner clamping angle pieces 25, 26 are held, so as to be prevented from moving away from said base surface, firstly by a profile wall 9 which projects from the base surface of the frame profile 29 and secondly by the profile wall 5 which is also abutted against by that clamping part 11 which serves for the fastening, according to the invention, of fittings in the frame profile 29.

The frame profile 29 as per FIG. 7 differs from the frame profile 1 predominantly discussed above in that it has a profile wall 30 which projects from that side of the base surface which is averted from the cavity, and said profile wall can perform the function of a glass strip, such that, per frame part piece, only a single separate glass strip 31 is required.

FIG. 8 shows—inter alia—the connection, designed according to the invention, of hinged parts to a pivoting door leaf and the associated, positionally fixed casing. Frame profiles 1 form the door casing. Frame profiles 29 (with integrally formed profile wall 30, which serves as glass strip) form the frame of the pivoting door leaf, which is in the form of a glass leaf. The shaft 34 about which the pivoting door leaf is pivotable relative to the casing is situated in front of the space enclosed by the frame profiles 1. Holding arms arranged one above the other project from the shaft 34 into the adjacent rebate surface between pivoting door leaf and casing, and said holding arms are connected there, by way of screws 16, to in each case one cover plate 36 and one clamping part 35 on the respective frame profile 1 and 29. Owing to the particularly high loads to be expected in this case, the cover plates 36 and the clamping parts 35 are connected to one another by way of in each case two connecting screws 16, rather than just one as in the case of the cover plates 17 and clamping parts 11 in the examples discussed above. In this case, too, the arrangement is visually inconspicuous, easy to install and detachably fastenable at any desired position along the longitudinal direction of the frame profiles 1, 29, without the need for any bores or milled-out portions for this purpose.

FIG. 8 furthermore shows how the frame profiles 1, 29 can be “upgraded” so as to have improved fire protection characteristics.

At the in each case left-hand side of the respective cavity of the frame profile 1, 29, there is clamped a heat shield 38. In this case, said heat shield has the shape of a flat U-shaped profile, wherein the free limbs bear against the respective side wall of the frame profile 1, 29, and thus the base of the flat U-shaped profile is arranged at a spacing from the respective side wall of the frame profile 1, 29. The free ends of the limbs of the U-shaped profile which forms a heat shield 38 are preferably equipped with a toothing such that they make contact with the frame profile 1, 29 not linearly but by way of a series of contact points, because in this way, heat conduction between the two parts is reduced. The heat shields 38 serve primarily for preventing heat from being radiated from one side surface of the cavity 2 of the frame profile 1, 29 to the other side surface. A particular advantage of the illustrated embodiment is that the heat shields 38 can also be retroactively inserted into the frame profiles 1 from the open side of the cavity 2—that is to say from the rebate surface—and clamped.

At the in each case right-hand side of the respective cavity of the frame profile 1, 29, there is inserted in each case one fire protection body 37. Said fire protection body 37 has the shape of a rectangular profile. It is composed of a heat-resistant, thermally insulating material, based for example on mineral wool or silicate. By contrast to the heat shield 38, said fire protection body not only deflects thermal radiation but also very greatly slows heat conduction.

By arranging different types, different thicknesses and different numbers of heat guard articles in the hollow chamber 2 of a frame profile 1, 29, the frame profile 1, 29 can be easily adapted in modular fashion to different fire protection classes such as F30, F60, F90 etc. This yields highly valuable economic advantages with regard to production and installation logistics.

For the clamping of fire protection body 37 and heat shield 38 for prevention of movement normal to the frame plane of the frame formed by the frame profiles 1, 29, the fire protection body 37 and heat shield 38 are in each case clamped between a side surface of the frame profile 1, 29 and further profile walls, wherein one of said further profile walls projects inward from the base surface of the frame profile; in the case of the frame profile 1, this is the profile wall 9.

In the frame profiles 1, 29 themselves, heat conduction is possible only through the base surface 3 (FIG. 2) from one side surface 4 (FIG. 2) to the other side surface 4. Said heat conduction can be very greatly slowed by virtue of the base surface 3 being provided with a pattern of apertures 8, as can be clearly seen in FIG. 2, such that the cross-sectional area for heat transfer by heat conduction in the material of the frame profile 1 is reduced, and the transmission path is lengthened. It is particularly advantageous for the apertures 8, as illustrated, to be elongated holes, the longitudinal direction of which lies parallel to the profile direction, and for multiple rows of elongated holes to be situated adjacent to one another with a longitudinal offset with respect to one another by in each case one half of the pattern dimension.

For the production of the apertures 8, it is highly advantageous for the frame profile 1 to have a single base surface 3, and not for example multiple base surfaces which enclose one or more hollow chambers. In this way, it is specifically possible for the apertures 8 to be easily formed by being punched out. In the case of hollow chambers, it would instead be necessary to perform milling, which entails a very much longer machining time and very much higher costs.

FIG. 9 shows, in two views, an advantageous design for connecting two frame profiles 1, which can be used in accordance with the invention, in a mitered configuration so as to form a frame for a door area or a window area. For this purpose, use is made of a corner clamping fitting 44 which is composed of four different components:

The supporting angle piece 45 is composed of two planar rectangular sheet-metal pieces which are connected to one another along in each case one short end side and which are at right angles to one another. In the cavity of the frame profiles 1 which bear against one another in a mitered configuration, the supporting angle piece 45 bears against the base surfaces 3 of said frame profiles.

Against the outside of the supporting angle piece 45 there lies a further angle piece, the so-called tension angle piece 46. It, too, is composed substantially of two planar sheet-metal rectangles which are connected to one another along their short end sides and which are at right angles to one another. The lateral end faces of the tension angle piece 46 are equipped with a toothing 47, the tips of which bear in each case against a profile wall 9 of a frame profile 1.

A screw 50 runs through a nut-type threaded bore in the tension angle piece 46. Said nut-type threaded bore runs through the tension angle piece 46 and lies diagonally with respect to the two limbs thereof. The screw 50 presses, by way of its inner end face with respect to the tension angle piece 46, against the boundary region between the two angle piece limbs of the supporting angle piece 45 situated at the inside. When screwed further toward the supporting angle piece 45, the screw has the effect that the tension angle piece 46 is pulled approximately diagonally away from the supporting angle piece 45.

Spreading bolts 49 are rigidly connected to the limbs of the supporting angle piece 45. Said spreading bolts are approximately of circularly symmetrical mushroom shape and project from the limbs of the supporting angle piece 45 into the elevated angle piece region between said limbs, and run in each case through an elongate aperture 48, running in the limb direction, on the respectively adjacent limb of the tension angle piece 46. The width of the aperture 48 decreases with increasing spacing to the connecting surface between the two limbs of the tension angle piece 46, and here, also becomes narrower than the diameter of the spreading bolts 49 in their longitudinal region running through the aperture 48.

The screwing of the screw 50 toward the supporting angle piece 45 causes the limbs of the tension angle piece 46 to be displaced on the supporting angle piece 45 toward the connecting line between the limbs thereof. In this way, longitudinal regions of the aperture 48 at which the width of the aperture, in the case of the non-deformed tension angle piece 46, is smaller than the diameter of that longitudinal part of the spreading bolts 49 which runs through the aperture arrive at spreading bolts 49. This has the effect that parts of the tension angle piece 46 situated at both sides of the aperture 48 of the tension angle piece 46 are spread away from one another, and the toothings 47 are pressed firmly against the profile walls 9 of the frame profiles 1, and thus the frame profiles 1 are, with the tension angle piece 46, displaced relative to the supporting angle piece 45 toward the miter surface between the two frame profiles 1.

The assembly of the miter connection can thus be performed in the extremely straightforward manner. It is furthermore advantageous that the frame profiles 1 do not have to be milled out or drilled for this purpose, and that the cavities 2 (FIG. 2) in adjacent frame profiles 1 remain substantially open toward one another. In this way, if necessary, it is possible for lines or cables to be easily guided in the frame profiles 1 even across frame corners, and it is possible for heat shields and insulating material to be fitted in the cavities 1 even at the corner region of frame profiles 1. For the attachment of heat shields and insulating material, it is particularly advantageous that—as shown—tension angle piece 46 and supporting angle piece 45 extend only between the two profile walls 9 and not as far as the side surfaces 4 of the frame profiles.

FIG. 10 depicts two versions of concealment profiles 51, 52 for the profile cavity 2 of frame profiles 1 that can be used in accordance with the invention, which concealment profiles are each intended to be clamped on the two profile walls 5 discussed above and bridge the spacing between the profile walls 5 so as to cover the profile cavity 2.

Here, the concealment profile 51 is a simple plastics extruded profile or a metal profile. It has primarily a visual function.

By contrast, the concealment profile 52 has not only the visual function but also a fire protection function and, for this purpose, is constructed from multiple different parts: the carrying profile 53 is a plastics extruded profile, and serves as a carrier for the other parts and is clamped to the profile walls 5 discussed above. Said carrying profile has a profile cavity which, at the rebate side, is concealed by a very thin profile wall 54. In the profile cavity there is arranged a fire protection swelling agent 55. In the event of a fire, the profile wall 54 melts away and the fire protection swelling agent 55 swells, whereby it absorbs energy and, in an intended manner, closes the gap between the two frame profiles 1. That delimiting wall of the profile cavity in the carrying profile 53 which is averted from the rebate side is concealed by a sheet-metal strip 56. This—by contrast to the carrying profile 53—maintains its stability even in the event of a fire and prevents the fire protection agent 55 from swelling in the wrong direction.

Two further forms of heat shields 60 are also depicted in the right-hand part of the profile cavities 2 of the frame profiles 1 in FIG. 10. Said heat shields are also, like the heat shields 38 in FIG. 8, typically formed by sheet-metal strips.

FIG. 11 shows, in the case of a frame profile 1 for use in accordance with the invention, further insert components in the profile cavity 2. Two further versions of heat shields 57 composed of sheet metal and clamped in the profile cavity 2 are depicted at the sides. A cable channel profile 58 in the form of a flat U-shaped profile is clamped between two profile walls 9 which project into the profile cavity 2 from the base surface 3 of the frame profile 1 and which are curved toward one another in hook-shaped fashion in the profile. The cable channel profile 58 is typically a plastics extruded profile. It bears against the frame profile 1 at the profile walls 9 by way of its free limb ends which are in the form of detent tips and which, between the profile walls 9, are bent toward one another slightly in relation to their relaxed position. The cable channel profile 58 conceals cables 59 with respect to the outer part of the profile cavity 2 of the frame profile 1.

FIG. 12 shows the design and installation situation for a clamping profile 107 in a frame profile 1, wherein the clamping profile 107 acts as a twofold heat shield. The clamping profile 107 is typically composed of sheet steel and has approximately a U-shaped cross-section form, wherein the limbs extend obliquely apart slightly, and wherein, in the elastically relaxed state, the free ends of the limbs bridge a spacing slightly greater than the extent to which those walls of the frame profile 1 against which said limb ends are intended to bear in the installed state are spaced apart. Thus, in the installed state, the free ends of the limbs of the clamping profile 107 bear under elastic preload against the frame profile 1 and thereby hold the clamping profile 107 without play in the frame profile 1 in non-form-fitting fashion. The base surface of the clamping profile 107 runs close to the base surface of the frame profile 1, though it is ideally—as depicted—arched away from said base surface slightly. Analogously to the apertures 8 of the frame profile 1 of FIG. 2, the base surface of the clamping profile 107 may have a pattern of apertures for impeding heat conduction.

The clamping profile 107, which constitutes a twofold heat shield, can be installed particularly quickly; it can however be installed only at longitudinal regions at which no clamping part according to the invention is to be attached.

FIG. 13 shows, on a frame profile 1 which is used in accordance with the invention as a frame part of a casing of a door, the installation of a smoke detector 66 which must function only when the door leaf is open. The central part of the smoke detector 66 is situated in the profile cavity 2 of the frame profile 1 and, for this purpose, is connected to a cover plate 68 and, according to the invention, is fastened with the latter to projecting profile walls 5 of the frame profile 1 by way of a clamping part 11, as already described further above on the basis of other fittings. In the example illustrated, the smoke detector 66 is connected via a cable to an LED display 67 which is inserted into a bore in a side surface of the frame profile 1 so as to be visible from the outside. In order that smoke can reach the smoke detector 66 in the first place, the cover plate 68 has slots 69 extending through it, and the seal which is situated between the frame profile 1 and the building wall to which the frame profile 1 is fastened locally has ducts extending through it which lead from the two spacings which are separated by the frame profile 1, through an opening in the base surface 3 of the frame profile 1, into the profile cavity 2 of the frame profile 1. In the example illustrated in FIG. 13, to realize the seal and ducts, a flat hollow body 70 which has at least three openings is arranged between frame profile 1 and adjacent building wall. In the hollow body 70 there is arranged a fire protection swelling agent 71 which, in the event of a fire, swells under the action of heat and closes the ducts of the hollow body 79.

FIG. 14 shows a frame profile 39, which is used in accordance with the invention, on a door leaf which has two outer layers 40 which are typically composed of wood and which laterally cover the frame profile 39. In that space region between the two outer layers which is not occupied by frame profiles 39, there is arranged a panel-like core 18 which is composed, for example, of a heat-insulating material. In the illustrated advantageous embodiment, one lateral wall of the frame profile 39 is, by way of a profile wall 81, elongated toward the rebate surface beyond the mere bordering of the profile cavity, and the second lateral wall of the frame profile 39 is, by way of a profile wall 83, elongated away from the rebate surface beyond the mere bordering of the profile cavity. Through the profile walls 81, 83, the outer layers 40 can be screwed by way of screws 41 to the frame profile 39, wherein the screws 41 penetrate into the outer layers 40 from the side averted from the visible side, which is self-evidently advantageous from a visual aspect.

FIG. 15 shows a frame profile 43 used in accordance with the invention on a door leaf 42 which is formed substantially as a thick wood panel, into the end faces of which there is milled a groove and into which there is inserted, at each end face, a frame profile 43. In this case, the frame profiles 43 and wood panel may be connected to one another by way of screws 41 which run through the base surface of the frame profile 43 from the profile cavity of the frame profile 43.

FIG. 16 shows an advantageous type of attachment for an adjustable block arrangement on a movable areal closure element, for example a glass door, which comprises frame profiles 90 according to the invention and a core (glass pane 32). In the case of an example of a pivoting door, the adjustable block arrangement is optimally attached to that end of the upper end face of the core which is averted from the pivot axis of the door. The block arrangement is composed of two acute-angled wedges 91, 92 and of a screw 93, wherein the two wedges 91, 92 are arranged at the corner region of two frame profiles 90, in the gap between the base surface of the horizontal frame profile 90 and the end face of the core (glass pane 32). The wedges 91, 92 bear against one another by way of in each case one of the two wedge faces thereof. By way of the second wedge face, the one wedge 91 bears against the base surface of the frame profile 90 and the second wedge 92 bears against the end face of the core. The screw 93 runs through a bore in the base surface of the vertical frame profile 90 into a nut-type bore on one wedge 91. By virtue of the screw 93 being tightened, the wedge 91 is pulled toward a vertical frame profile 90, whereby the total thickness of the block arrangement as formed by the sum of the thicknesses of the two wedges 91, 92 increases, and thus the horizontal frame profile 90 is lifted in relation to the core. For the variation of the thickness of the block arrangement, it is merely necessary, with the door open, for the possibly provided concealment of the profile cavity of the upper part of the lock-side vertical frame profile 90 to be removed, and for the head, situated in the profile cavity, of the screw 93 to be rotated by way of a screwdriver. By contrast to conventional designs of block arrangements, it is thus not necessary to remove a glass strip in order to change the thickness of the block arrangement, and therefore, the associated handling of the seal material to be arranged between glass strip and glass pane is eliminated.

FIG. 17 shows, in a profile view, for example on a glass door leaf, the use of a frame profile 72 used in accordance with the invention, which frame profile is formed from two separate profile parts 73, 76. The two profile parts 73, 76 form substantially the side surfaces of the profile 72, which between them enclose the profile cavity 74.

As in the example of FIG. 1, on the side facing toward the rebate surface, the profile cavity 74 is bridged by a clamping part 11, a cover plate 17, and a screw 16 which pulls said clamping part and cover plate together, in that two profile walls, which project beyond the profile cavity 74, of the frame profile 72 are clamped between clamping part 11 and cover plate 17.

Instead of the otherwise provided base surface of the frame profile, there is arranged, on that side of the profile cavity 74 which is averted from the rebate surface, a series of multiple screw connections 21 which function as already described on the basis of FIG. 1. Said screw connections each have a clamping part 22, a counterpart plate 23 and a screw 24, wherein the screw 24 pulls the clamping part 22 and the counterpart plate 23, in which a nut-type thread is situated, together, and edge regions of clamping part 22 and counterpart plate 23 in each case clamp a projecting profile wall 75 of a sub-profile 73, 76 between them. For reasons relating to the installation sequence, the screw connection 21 is oriented such that the head of the screw 24 that is required is arranged in the profile cavity 74, and not outside the profile cavity, as in the case of the screw connection as per FIG. 1.

The design with two sub-profiles 73, 76, which are locally connected to one another, for forming a frame profile 72 offers material savings and better modularity than designs with a monolithic frame profile, and eliminates the need for separate glass strip profiles. The design however also leads to reductions in strength and work outlay during the installation process. The design may be expedient in particular if doors or windows are required in the case of which particular, only seldomly arising frame thicknesses are required.

FIG. 18 shows a frame profile which can be used in accordance with the invention and which is formed as a composite of three sub-profiles 77, 80, 82 arranged in parallel with respect to one another. The central profile 77 is substantially in the form of a U-shaped profile in which the free limb ends are curved inward, that is to say beyond the profile cavity 78, and are connected to one another, in the manner already described, by way of screw connections which are formed in each case from a clamping part 84, a cover plate 85, and a screw 86. The side surfaces of the central profile 77 however also have in each case two outwardly projecting wall regions. By way of said outwardly projecting wall regions, the side surfaces of the central profile 77 are connected by way of further screw connections according to the invention, which are formed in each case from a clamping part 88, a cover plate 87 and a screw 89, to in each case one further sub-profile 80, 82.

Said design is particularly advantageous if, for adaptation to different requirements of insulation and/or fire protection classes, a high level of modularity is required.

FIG. 19 shows, in a sectional view, frame profiles 108, 109 which can be used in accordance with the invention and which are formed, for the purposes of heat insulation, from in each case three sub-profiles. The lateral sub-profiles are, in the conventional manner, composed of metal, typically from rolled sheet steel in the example illustrated. The central sub-profiles 110, 111 are composed of a material with much poorer thermal conductivity than metal, such as in particular plastic or a composite material composed of non-metallic fibers and a plastic. The individual sub-profiles are clamped together, that is to say engaged by way of individual profile wall surfaces into one another, such that a wall region of a sub-profile is encompassed by wall regions of the adjacent sub-profile oriented parallel thereto. Here, in the connecting region, the sub-profiles preferably bear against one another under elastic compressive preload. The sub-profile (110, 111) composed of the lower-strength and elastically softer material is preferably that sub-profile of which a wall region is encompassed by wall regions of the adjacent profile. If the metallic, lateral sub-profiles are formed from sheet metal by roll forming, the central, heat-insulating sub-profile (110, 111) may be connected already during the roll-forming process. If the metallic, lateral sub-profiles are aluminum extruded profiles, the connection is realized by virtue of the central sub-profile being retroactively pressed in.

FIG. 20 shows, based on the example of a door leaf 42 composed of solid wood in which a frame profile 94 is used in accordance with the invention, a highly advantageous installation configuration for a fitting 19, formed by a lock casing 19, and the associated handle rosette 101.

The lock casing 19 is arranged in the frame profile 94 and is fastened thereto according to the invention, as already described on the basis of FIG. 1, by way of a cover plate, a clamping part and a screw. In addition to the lock casing 19, a holding part 96 is arranged in the frame profile 94. The holding part 96 is typically composed of sheet steel; it is for example in the shape of a U-shaped profile and, as such, is arranged in the frame profile 94 so as to be parallel thereto, wherein the outwardly curved free end regions of the profile limbs thereof are, in the elastic region, bent together slightly in relation to their relaxed position, such that they thus bear under pressure against the inner side of the side surfaces of the frame profile 94 and thus hold the holding part 96 in force-fitting but not form-fitting fashion in the frame profile 94. The lock casing 19 projects through a recess 97 in the base surface of the holding part 96. The handle shaft 100 (commonly a square profile) projects, from the lock casing 19, normal to the plane of the door leaf 42 through an aperture 99 through a limb of the holding part 96, and through an aperture 95 through a side wall of the frame profile 94, and through an aperture 61 on the door leaf 42. The aperture 95 through the frame profile 94 and the aperture 61 through the door leaf 42 are dimensioned to be considerably wider than the cross-sectional dimensions of the handle shaft 100. The handle shaft 100 furthermore runs through a passage bore in the handle rosette 101, wherein, however, the cross-sectional dimensions of said passage bore are so narrow that the handle shaft 100 is held therein without play, so as to be prevented from moving in translational fashion normal to its longitudinal direction. From the handle rosette 101, at a spacing from the handle shaft 100, screws 102 extend through screw passage bores, of wide dimensions, in the door leaf 42 and in the frame profile 94 to threaded bores 98 on a deep-drawn region on the holding part 96.

During the installation of the arrangement, it is firstly the case that the holding part 96 is pushed into the frame profile 94. Then, in accordance with the invention as described on the basis of FIG. 1, the lock casing 19 is fastened by way of cover plate, clamping part and connecting screw to the frame profile 94, specifically in such a way that said lock casing extends into the space between the limbs of the holding part 96 and projects through the recess 97 thereof, and in such a way that the handle shaft 100 can be inserted through the associated recesses on door leaf, frame profile and holding part into the bearing receptacle, provided for the same, on the lock casing 19. When the handle shaft 100 has been inserted, and the handle rosette 101 mounted thereon, the screws 102 are inserted through the screw passage bores in the handle rosette 101 and through the screw passage bores, which are of very wide dimensions for said screws, on the door leaf 42 and on the frame profile 94, into the associated threaded bores 98 on the holding part 96, and said screws are initially cautiously tightened, and here, the handle rosette 101 is fixed to the door leaf in precisely the position in which the handle shaft runs optimally, without bending and constraint, through the associated passage bore on the handle rosette. The holding part 96, which is still displaceable in the frame profile 94 in the presence of slight tension in the screws 102, slides, during the tightening of the screws 102, either automatically, or by virtue of said holding part being suitably displaced by way of a tool from the open side of the frame profile 94, approximately exactly into the optimal position in which the screws 102 are oriented normal to the door leaf plane when the handle rosette 101 is optimally positioned. If the screws 102 are now tightened with force, the handle rosette 101 is fixed exactly in the correct position, so as to be free from play for years, in order to guide the handle shaft 100 such that it is aligned, so as to be free from bending and constraint, with the associated axis of the receptacle in the lock casing 19.

(In the case of designs according to the prior art, the position of the holding screws for the handle rosette relative to the door leaf is exactly predefined, whereby tolerances with regard to the position of the lock casing relative to the door leaf inevitably lead to unsuitable mounting of the handle shaft, which as a further result gives rise to a poorly pivoting handle, and to destruction of pivoting mechanisms.)

The frame profiles according to the invention that have been shown and discussed are best manufactured from steel or aluminum, wherein roll forming and extrusion are to be mentioned as the most important manufacturing methods. For applications in which relatively low strength requirements may exist, it may however also be advantageous for the frame profiles to be in the form of plastics extruded profiles.

1. A device for closing a building opening, wherein an areal closure element and/or a casing which is fastened rigidly to the edge of the building opening has a frame profile which, by way of two side surfaces, delimits a profile cavity that is open toward the rebate surface, wherein, from each of the two side surfaces, a profile wall projects in the direction of the respective other side surface, and wherein, to said projecting profile walls, there are fastened a cover plate and a clamping part which bridge the spacing between the profile walls and which are pulled together, with the interposition of the profile walls, by one or more screws,
wherein,
on the two projecting profile walls, the clamping part bears in each case against both flanks of a groove which is formed on the projecting profile wall and the opening area of which lies parallel to the connecting surface between the two projecting profile walls.

2. The device as claimed in claim 1, wherein the spacing between the flanks of the groove at the region against which the clamping part bears narrows with increasing groove depth.

3. The device as claimed in claim 1, wherein the cover plate, by way of its two side surfaces which lie parallel to the profile direction of the frame profile bears areally against the frame profile.

4. The device as claimed in claim 1, wherein the cover plate is part of a fitting which performs not only the connecting function between the profile walls but also a further function.

5. The device as claimed in claim 1, wherein the clamping part and the cover plate are provided exclusively for increasing the mechanical stability of the frame profile.

6. The device as claimed in claim 1, wherein a region, which bears against the groove, of the clamping part has a toothing at the contact surface with the groove.

7. The device as claimed in claim 1, wherein the cross-sectional area of the frame profile has no closed hollow chambers.

8. The device as claimed in claim 1, wherein a sliding block of a slide-rail-type door closer is arranged in the profile cavity of the frame profile, and is guided slidingly on profile walls of the frame profile.

9. The device as claimed in claim 8, wherein, in the profile cavity of a further frame profile, there is arranged a rotary drive for the pivoting movement of a pivot arm of the slide-rail-type door closer.

10. The device as claimed in claim 1, wherein the frame profile has a base surface which connects the side surfaces and which has a pattern of apertures.

11. The device as claimed in claim 10, wherein the apertures are formed by punching or milling.

12. The device as claimed in claim 10, wherein the apertures are formed by punching.

13. The device as claimed in claim 1, wherein the frame profile has a base surface which connects the side surfaces, and in that screws run through the base surface into a glass strip.

14. The device as claimed in claim 1, wherein the frame profile has a base surface which connects the side surfaces, and in that two profile walls project, at a spacing from the side surfaces and at a spacing from one another, from the base surface into the profile cavity.

15. The device as claimed in claim 1, wherein a heat shield and/or a fire protection body and/or fire protection swelling agent are arranged in the profile cavity of the frame profile.

16. The device as claimed in claim 1, wherein two frame profiles are arranged in a mitered configuration with respect to one another, and in that corner clamping angle pieces, which have in each case two profile limbs oriented at right angles with respect to one another, are inserted by way of in each case one profile limb into the profile cavity of each frame profile, wherein the profile limbs bear against the side surfaces of the frame profiles and against profile walls, which lie normal to said side surfaces, so as to form an interference fit.

17. The device as claimed in claim 1, wherein two frame profiles are arranged in a mitered configuration with respect to one another, and in that, proceeding from the miter surface, a corner clamping fitting extends along the base surface of both frame profiles, wherein the corner clamping fitting has a supporting angle piece which bears in slidingly guided fashion against the base surfaces, and a tension angle piece, which is rigidly connected to both frame profile, and a screw, which extends in the miter plane between tension angle piece and supporting angle piece and which is in threaded engagement with a nut-type threaded bore on one of the two angle pieces.

18. The device as claimed in claim 1, wherein a concealment profile is clamped between the two projecting profile walls of a frame profile.

19. The device as claimed in claim 18, wherein the concealment profile has a fire protection swelling agent.

20. The device as claimed in claim 19, wherein the concealment profile comprises a sheet-metal strip which is arranged on that side of the fire protection swelling agent which is averted from the rebate surface.

21. The device as claimed in claim 1, wherein a cable channel profile is clamped in the profile cavity.

22. The device as claimed in claim 1, wherein a smoke detector is installed in the profile cavity of the frame profile.

23. The device as claimed in claim 21, wherein the smoke detector is connected to a cover plate through which slots extend.

24. The device as claimed in claim 21, wherein the base surface of the frame profile is connected by way of ventilation ducts to the space regions adjacent to the frame profile.

25. The device as claimed in claim 1, wherein the areal closure element has a frame composed of frame profiles, which frame surrounds a core, wherein, at a corner region, between core and frame, there is arranged a block arrangement which is formed by two wedges which bear against one another and which are displaceable relative to one another, and wherein the wedge is equipped with a nut-type threaded bore which is in engagement with the threaded part of a screw, wherein the head of the screw is situated in the profile cavity of a frame profile, and the screw bolt extends through a bore in the base surface of the frame profile.

26. The device as claimed in claim 1, wherein it has a frame profile which, on the outer side of its side surfaces, has projecting profile wall regions to which further sub-profiles are fastened, wherein the connection between the frame profile and a sub-profile has clamping parts, cover plates and screws which pull these together, wherein profile walls are clamped between clamping parts and cover plates, and the clamping parts bear against the flanks of grooves on the clamped-in profile walls.

27. The device as claimed in claim 1, wherein it has a frame profile, the two side surfaces of which are independent, individual monolithic profile parts and which are connected to one another by virtue of clamping parts and counterpart plates being pulled together by screws and, between them, clamping projecting profile walls of in each case two profile parts, wherein the clamping part on the two projecting profile walls bears in each case against both flanks of a groove which is formed on the projecting profile wall and the opening area of which lies parallel to the connecting surface between the two projecting profile walls.

28. The device as claimed in claim 1, wherein the frame profile comprises two lateral and one central sub-profile(s) which are arranged parallel to one another and which are clamped to one another, wherein the two lateral sub-profiles are composed of metal and do not make contact with one another, and wherein the central sub-profile is composed of a material which exhibits considerably poorer heat conductivity than metal, such as in particular plastic.

29. The device as claimed in claim 1, wherein a frame is formed by frame profiles, wherein a lock casing is arranged in the profile cavity of one of the frame profiles, wherein a surface of a holding part extends between a side surface of the lock casing and a side wall of the frame profile, wherein, from the lock casing, a handle shaft extends, normal to the plane of the frame, through a handle rosette, wherein screws extend from the handle rosette through apertures into threaded bores on the holding part, wherein an aperture through the frame profile and an aperture through the possibly provided coating of the door leaf are wider than the cross-sectional dimensions of the handle shaft running through them, and wherein the apertures for the screws through the frame profile and through the possibly provided coating of the door leaf are wider than the cross-sectional dimensions of the screws running through them, and wherein the holding part is held in position in form-fitting fashion in the frame profile when the screws are not tightened.

30. The device as claimed in claim 1, wherein it has two of the areal closure elements, which are the pivotable leaves of a fire protection door, wherein one leaf is an underlying, inactive leaf and the second leaf is an overlying, active leaf, and wherein the leaves have opening and closing sequence control.
